(19) United States
(12) Patent Application Publication
(10) Pub. No.: US 2014/0010499 A1
(43) Pub. Date: Jan. 9, 2014

(54) OPTICAL CONNECTOR FERRULE

(71) Applicant: Furukawa Electric Co., Ltd., Tokyo (JP)

(72) Inventors: Katsuki SUEMATSU, Tokyo (JP); Tsunetoshi SAITO, Tokyo (JP); Takayuki ANDO, Tokyo (JP); Mitsuhiro IWAYA, Tokyo (JP)

(73) Assignee: Furukawa Electric Co., Ltd., Tokyo (JP)

(21) Appl. No.: 13/966,932

(22) Filed: Aug. 14, 2013

Related U.S. Application Data
(63) Continuation of application No. PCT/JP2012/053353, filed on Feb. 14, 2012.

(30) Foreign Application Priority Data
Feb. 17, 2011 (JP) 2011-031676

(51) Int. Cl. G02B 6/38

(52) U.S. Cl. CPC G02B 6/3881
USPC 385/65

(57) ABSTRACT

The optical connector ferrule has a second alignment board and a housing part having a first alignment board and a pair of side support parts. The first alignment board has a surface in which bare fiber parts of a optical fiber ribbon are positioned in a width direction and has holding grooves for arranging bare fiber parts. Side support parts support ends of the first alignment board and have an open part larger than a width of the ribbon in a upper and/or lower surface side of the first alignment board. The second alignment board has a positioning part for positioning in the width direction by engaging with a part of bare fiber parts on holding grooves and a fixing part for pressing and fixing bare fiber parts. The second alignment board is arranged to face the first alignment board and to sandwich bare fiber parts.

### TECHNICAL FIELD

The present invention relates to an optical connector ferrule used in a connecting part of optical modules such as optical semiconductors or a connecting part between optical fibers in the optical communication field.

### BACKGROUND ART

Recently, in the high-end system such as a super computer, there is a trend for larger capacity and higher rate of communicating information due to parallel operation of plural CPUs. Between ports and systems in such a system, information signals need to be transmitted at high rates and with large capacity.

However, the electric transmission system of transmitting information signals with use of electric signals has limitations as to the transmission rate, transmission loss and the like. Therefore, attention has been focused on the transmission technique with use of optical fibers and the optical interconnect technique has been expected. With this technique, high-speed and high-density wiring can be realized with light weight and smaller diameter by replacing the conventional coaxial cable bundles with optical fiber arrays composed of plural optical fibers. Further, as compared with the conventional electric transmission system, the signal transmission system enables signal transmission in a much broader band and using of smaller-sized and lower power consumption optical modules.

In order to realize high-density wiring with use of the optical interconnect technique, there is a demand for an optical connector ferrule capable of arranging plural optical fiber ribbons with great positioning accuracy and at high densities at connecting parts of the optical fibers.

Recently, there are greater demands for an optical connector ferrule capable of stacking plural optical fiber ribbons at multiple stages and connecting forty-eight or more optical fibers at high densities. Such high-density connection requires the technique of arranging thin optical fibers at multiple stages with high positioning accuracy. As such an optical fiber fixing member (ferrule) for connecting optical fibers at high densities, there are several structures proposed.

The PL1 (Patent Literature 1) discloses an optical connector ferrule (optical fiber mounting member) which has a first housing part with plural fiber insertion holes and a second housing part with a flange part. The plural fiber insertion holes provided in the first housing part must be extremely fine holes of about 80 to 125 μm for insertion of thin optical fibers. In order to form such insertion holes with high accuracy, it is necessary to use a mold die which has plural fine core pins (thin mold pins) arranged adjacent to each other and thus enhanced manufacturing technique is required. In the optical connector ferrule disclosed in the PL1, the first housing part requires high-accurate forming of insertions holes and the second housing part does not require high accuracy. These housing parts are formed as separate members and connected to each other, thereby enhancing the accuracy of the first housing part while reducing the manufacturing cost of the mold die and simplifying the manufacturing work as much as possible.

The PL2 (Patent Literature 2) discloses an optical connector ferrule which has a housing and a transverse optical connector ferrule. The housing has a center division plate at the center and transverse insertion holes are formed at upper and lower parts of the center division plate. The transverse optical connector ferrule is inserted into the insertion hole and has fiber holes. In the upper and lower parts of the center division plate, V grooves are formed for placing optical fibers. The optical fibers are arranged and aligned in the V grooves, and the transverse ferrule with the optical fibers inserted is fit into the insertion hole. With this structure, the four optical fiber ribbons can be arranged. The positioning of the transverse ferrule to be inserted is defined by the inner size of the insertion hole of the housing and the outer size of the ferrule.

Further, the PL3 (Patent Literature 3) discloses a multi-fiber ferrule which has outer support members 12 and inner support members 14. Outer support members 12 are arranged at the uppermost stage and the undermost stage. Grooves are formed on the upper and lower surfaces of inner support members 14 and plurality of inner support members 14 can be stacked. Positioning of optical fibers arranged in the V grooves is conducted by guide pin holes 20. Each guide pin hole 20 is formed by combining two support members vertically adjacent to each other.

### Citation List

### Patent Literature

### [PL1] Japanese Patent Application Laid-Open No. 2009-229503

### [PL2] Japanese Patent Application Laid-Open No. 2009-229505

### [PL3] Japanese Patent No. 3753919

### SUMMARY OF INVENTION

### Technical Problem

In the PL1, it is necessary to form plural insertion holes in the first housing part 11 for inserting bare optical fibers. As described above, in order to form such insertion holes for the optical fibers, it is necessary to form plural thin and long mold pins in the mold die. Such a mold die with thin mold pins is difficult to be manufactured with great accuracy and the manufacturing cost is high. Besides, in molding the housing with use of this mold die, sometimes the mold pin is bent or broken due to some factor.

Hence, the ferrule of the PL1 has problems that creation of the mold die and handling in the molding work are difficult, it is difficult to improve the yields and work efficiency in the manufacturing process of the housing and it is also difficult to reduce the manufacturing cost as the mold die is expensive. There is another problem that the assembly work of inserting the optical fiber parts into thin and long insertion holes needs skill and the assembly work is hard.

Further, there is a future need to connect ninety-six optical fibers which are much more than the conventional forty-eight optical fibers. In such a case, the pin diameter becomes drastically reduced from the conventional 125 μm to 80 μm. Therefore, the structure of the ferrule having insertion holes of the PL1 has limitations as to the manufacturing work of the ferrule and mold die.

In the PL2, the transverse ferrule inserted in the housing body is also an insertion type in which optical fibers are inserted. Accordingly, the PL2 has the same problems as the PL1. Further, the optical connector ferrule of the PL2 is configured to fit the alignment board in the housing. Therefore, positioning of the other ferrule to be inserted is determined by only the inner size of the insertion hole of the housing body and the outer size of the ferrule. Thus, it is problematically difficult to correct the position when there occurs a positional error in the width direction. Further, when the number of the other e ferrules is increased, the positioning accuracy is further lowered. Therefore, in the large packaging densities such that the five or more alignment boards are stacked, the high positioning accuracy is difficult to be maintained.

In the related art of the PL3, no insertion hole is used and the optical fibers are arranged and fixed with use of V grooves. It does not have the problem caused by the formation of insertion holes like the PL1 and PL2. However, in this multi-fiber ferrule, a guide pin hole is formed by combining two support members provided adjacently and this guide pin hole is used to position the V groove of each support member. Therefore, the positioning of each V groove is unstable and thus it is difficult to position with accuracy. Besides, the more fiber ribbons are stacked, the higher the possibility of shifting the position of the support member. Accordingly, when there is need for higher packaging densities, the accurate positioning is difficult in the technique of the PL3.

The present invention was carried out in view of the foregoing and aims to provide an optical connector ferrule for connecting a plurality of optical fibers in multi stage and high density, the optical connector ferrule being capable of facilitating the assembly process and arranging bare optical fiber parts with high positioning accuracy.

### Solution to Problem

In order to solve the above-mentioned problems, an optical connector ferrule according to a first embodiment of the present invention is an optical connector ferrule comprising a housing part and a second alignment board. The housing part has a first alignment board and a pair of side support parts, the first alignment board having at least one surface on which holding grooves are formed so that a plurality of bare fiber parts of a optical fiber ribbon are positioned in a width direction at a predetermined pitch and the bare fiber parts are arranged in alignment, the side support parts being formed integral with the first alignment board, supporting both ends of the first alignment board and having an open part in at least one of a upper surface side and a lower surface side of the first alignment board, the open part being larger than a width of the optical fiber ribbon. The second alignment board has a positioning part and a fixing part. The positioning part is used for positioning in the width direction and in engagement at least a part of the bare fiber parts placed on the holding grooves of the first alignment board. The fixing part is used for pressing and fixing the bare fiber parts. The second alignment board faces the first alignment board of the housing part and is arranged on and adhesive-fixed so as to sandwich the bare fiber parts.

According to another aspect of the present invention, it is preferable in the optical connector ferrule that the holding grooves are formed in both surfaces of the first alignment board.

According to still another aspect of the present invention, it is preferable in the optical connector ferrule that the first alignment board is formed at a center between the side support parts.

According to still another aspect of the present invention, it is preferable in the optical connector ferrule that the first alignment board has a fiber support part for supporting a covered part of the optical fiber ribbon in which optical fibers are covered.

According to still another aspect of the present invention, it is preferable in the optical connector ferrule that the housing part has a front housing part having the fiber support part and a back housing part having the second alignment board.

According to still another aspect of the present invention, it is preferable in the optical connector ferrule that the holding grooves formed on one surface of the first alignment board and the holding grooves formed on the other surface of the first alignment board are symmetrical.

According to still another aspect of the present invention, it is preferable in the optical connector ferrule that the holding grooves of the first alignment board and the positioning part of the second alignment board are V shaped grooves having V shaped cross sections.

According to still another aspect of the present invention, it is preferable in the optical connector ferrule that the holding grooves of the first alignment board and the positioning part of the second alignment board are U shaped grooves having U shaped cross sections.

According to still another aspect of the present invention, it is preferable in the optical connector ferrule that the holding grooves of the first alignment board and the positioning part of the second alignment board are shifted horizontally from each other by a half pitch.

According to still another aspect of the present invention, it is preferable in the optical connector ferrule that the first alignment board has a plurality of notch parts for separating from the pair of the side support parts.

### Advantageous Effects of Invention

According to the optical connector ferrule (optical fiber fixing member) of the present invention, as the plural optical fibers arranged are all fixed in the holding grooves, no insertion hole for the optical fibers is required. In this way, as the optical fibers are arranged and fixed in the holding grooves in position, it is possible to realize the optical connector ferrule that responds to demands for greater packaging densities and smaller-diameter optical fibers.

In other words, as the mold die for forming the V-shaped or U-shaped holding grooves can be formed by cutting, even when the optical fiber has smaller diameter of about 80 μm, the mold die can be formed relatively easily. Besides, the mold die with thin pins is not required, the manufacturing cost for the mold die can be reduced. Furthermore, the manufacturing cost can be also reduced as the manufacturing work of the ferrule can be facilitated by the mold die.

Further in this invention, the positioning parts are provided in the second alignment board to engage with the bare fiber parts arranged in the first alignment board. With this structure, it is possible to self-align and position the second alignment board by placing the second alignment board on the bare fiber parts arranged in the first alignment board and fitting the holding grooves of the second alignment board to the optical fibers arranged on the first alignment board. That is, the optical fibers stacked at multiple stages can be positioned properly by first arranging the bare fiber parts on the housing part and the second alignment board and then, superposing the second alignment boards sequentially. Further, as the side support parts with guide holes for positioning are formed integral with the first alignment board, it is possible to achieve high accuracy in positioning by butting and connecting the two optical connector ferrules.

In this way, as this is such a simple structure that bare fiber parts are arranged in the holding grooves, even when the optical fiber has a smaller diameter (for example, about fiber diameter Φ80 μm) and when optical fiber ribbons having more fibers (core fibers) are used, the optical connector ferrule can be assembled with great accuracy and by a simple work without molding of thinner mold pins.

As described above, according to the optical connector ferrule of the present invention, it is possible to enhance the positioning accuracy. Besides, as no insertion hole is required to be formed, it is possible to facilitate manufacturing of a die, reduce damage to the die, reduce the manufacturing cost drastically and enhance the assembly efficiency of fixing the optical fibers significantly.

### BRIEF DESCRIPTION OF DRAWINGS

FIG. 1A is an exploded perspective view illustrating the assembly process of an optical connector ferrule according to a first embodiment of the present invention;

FIG. 1B is a front view of the optical connector ferrule illustrated in FIG. 1A in which optical fiber ribbons stacked;

FIG. 2A is an exploded perspective view illustrating the assembly process of an optical connector ferrule according to a second embodiment of the present invention;

FIG. 2B is a front view of the optical connector ferrule illustrated in FIG. 2A in which optical fiber ribbons stacked;

FIG. 3A is an exploded perspective view illustrating the assembly process of an optical connector ferrule according to a third embodiment of the present invention;

FIG. 3B is a front view of the optical connector ferrule illustrated in FIG. 3A in which optical fiber ribbons stacked;

FIG. 4A is an exploded perspective view illustrating the assembly process of an optical connector ferrule according to a fourth embodiment of the present invention;

FIG. 4B is a front view of the optical connector ferrule illustrated in FIG. 4A in which optical fiber ribbons stacked;

FIG. 5A is a front view illustrating a housing part of an optical connector ferrule according to a fifth embodiment of the present invention;

FIG. 5B is a front view illustrating the optical connector ferrule having the housing part of FIG. 5A;

FIG. 6 is a front view illustrating an optical connector ferrule according to a sixth embodiment of the present invention;

FIG. 7A is an exploded perspective view illustrating the assembly process of an optical connector ferrule according to a seventh embodiment of the present invention;

FIG. 7B is a front view of the optical connector ferrule illustrated in FIG. 7A in which optical fiber ribbons stacked;

FIGS. 8A and 8B are front views each illustrating an optical connector ferrule according to another embodiment of the present invention;

FIGS. 9A and 9B are front views each illustrating an optical connector ferrule according to still another embodiment of the present invention;

FIG. 10A is a perspective view illustrating another example of an optical connector ferrule according to another embodiment of the present invention;

FIG. 10B is a perspective view illustrating a back side of the optical connector ferrule of FIG. 10A;

FIGS. 11A to 11C are views illustrating the assembly process of connecting optical fiber ribbons to the optical connector ferrule according to the embodiment shown in FIGS. 10A and 10B, FIG. 11A being an exploded perspective view illustrating the optical connector ferrule before assembly, FIG. 11B being a perspective view the optical connector ferrule in the assembled state and FIG. 11C being a perspective view of the optical connector ferrule in the assembled state of FIG. 11B seen from the back side; and

FIG. 12 is an exploded perspective view illustrating another embodiment of the present invention.

### DESCRIPTION OF EMBODIMENTS

With reference to the drawings, preferable embodiments of the present invention will be described in detail below.

### First Embodiment

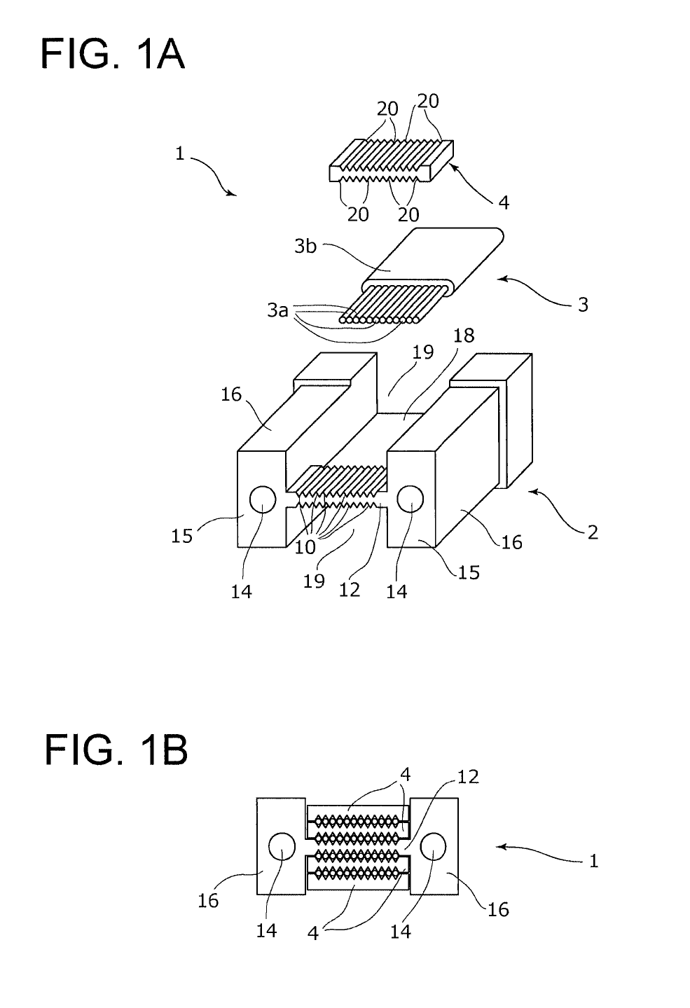

FIG. 1A is an exploded perspective view illustrating the assembly process of an optical connector ferrule 1 according to the first embodiment of the present invention, and FIG. 1B is a front view illustrating the optical connector ferrule 1 of FIG. 1A in which four layers of optical fiber ribbons 3 are stacked.

The optical connector ferrule 1 illustrated in FIG. 1A has a housing part 2 and a second alignment board 4. The housing part 2 has a first alignment board 12.

An optical fiber ribbon 3 is a multi-fiber ribbon arranged on the optical connector ferrule 1. The optical fiber ribbon 3 is such that a plurality of optical fibers (optical core fibers) is arranged in one direction and covered with a cover. The cover at an end of the optical fiber ribbon 3 is removed by a predetermined length and exposed to make bare fiber parts 3a appear, which are arranged accurately in a plurality of holding grooves 10 of the housing part 2 of the optical connector ferrule 1. Here, this embodiment is described by way of example using an optical fiber ribbon that has twelve optical fibers, but this is not intended for restricting the present invention. Any optical fiber ribbon with two or more optical fibers may be used and 96 or more optical fibers may be arranged totally in one optical connector ferrule.

The housing part 2 has the first alignment board 12 with the holding grooves 10, a pair of side support parts 16, a fiber support part 18, a flange part and an open part 19 and is formed of PPS, for example. The holding grooves 10 maybe provided equal in number to the bare fiber parts 3a, however, more holding grooves 10 may be provided to support various optical fiber ribbons with different numbers of optical fibers.

At a front part 15 of each of the paired side support parts 16 has a positioning guide hole 14 formed at a center thereof. When the optical connector ferrule is connected to another optical connector ferrule (not shown) having a positioning guide pin, both optical connector ferrules can be positioned properly relative to each other by inserting the positioning guide pin into the positioning guide hole 14. Besides, in the present embodiment, the fiber support part 18 is provided for supporting the covered part 3b of the optical fiber ribbon 3. The paired side support parts 16, the first alignment board 12 and the fiber support part 18 are preferably formed into one piece.

In the first alignment board 12 shown in FIG. 1, the holding grooves 10 each having a V-shaped cross section are formed in upper and lower surfaces of the flat board in a symmetrical manner and at a predetermined pitch. Here, in this embodiment, the holding grooves 10 which are equal in number (twelve) to the bare fiber parts 3a are formed in each surface of the first alignment board 12, however the numbers of holding grooves 10 maybe differentiated in the upper and lower surfaces. Besides, in FIG. 1, the first alignment board 12 is arranged approximately at a center in a height direction of the pared side support parts 16, however it may not be arranged at the center, as described later.

The upper and lower spaces of the surfaces of the first alignment board 12 in which the holding grooves 10 are formed are open spaces (open parts 19) and optical fiber ribbons 3 and second alignment boards 4 maybe inserted into both of the upper and lower spaces and arranged.

The second alignment board 4 has positioning grooves (positioning parts) 20 formed at a predetermined pitch in the upper and lower surfaces of the flat board. Each positioning groove 20 has a V shaped cross section. In this embodiment, the positioning grooves 20 in the upper surface serve as holding grooves for the bare fiber parts arranged on the second alignment board 4. In this embodiment, the plural positioning grooves 20 in the upper surface of the second alignment board 4 are formed at the same positions as those in the lower surface and they may be symmetrical with respect to the second alignment board 4. Also in this embodiment, the number of the positioning grooves 20 is equal to the number of bare fiber parts 3a aligned and the positioning grooves 20 are formed at the same pitch as that of the holding grooves 10 of the first alignment board 12 placed oppositely. However, the number and pitch of the positioning grooves 20 may be modified appropriately as far as the pitch of the positioning grooves 20 is integral multiple of the pitch of the positioning grooves 10 and the positioning grooves 20 are arranged at the aligned positions with the holding grooves 10. In FIG. 1A, only one second alignment board 4 is shown, however, as illustrated in FIG. 1B, plural second alignment boards 4 may be arranged on the upper surface and lower surfaces of the first alignment board 12.

Further, between the second alignment board 4 and each side support part 16 of the housing part 2, there may be formed a gap which is a pitch size of bare fiber parts fixed to the first alignment board 12 when the second alignment board 4 is placed on the housing part 2. With this structure, it is possible to adjust positioning if a position error is occurred in manufacturing of positioning groves 20 of the second alignment board and the bare fiber parts 3a aligned in the holding grooves 10.

Next description is made about the assembly method of the optical connector ferrule 1 described above by placing and aligning bare fiber parts 3a.

As illustrated in FIG. 1A, first, the optical fiber ribbon 3 from which a cover at an end is removed is placed on the first alignment board 12 via the upper open part 19 of the housing part 2. At this time, the bare fiber parts 3a of the optical fiber ribbon 3 are arranged in the holding grooves 10 of the first alignment board 12, respectively, and the covered part 3b is arranged on the fiber support part 18.

After that, the second alignment board 4 is placed to be superposed on the bare fiber parts 3a arranged in the holding grooves 10. At this time, it is placed in such a manner that the bare fiber parts 3a arranged on the first alignment board 12 are fit in the positioning grooves 20 formed in the lower surface of the second alignment board 4, thereby positioning the bare fiber parts 3a and the second alignment board 4.

In this way, after the second alignment board 4 is superposed, an adhesive agent is injected to the positioning grooves 20 and the holding grooves 10 for bonding. The adhesive agent may be epoxy adhesive or any other that a person having ordinary skill in the art uses generally.

In the upper surface of the second alignment board 4, positioning grooves 20 are formed corresponding to the positioning grooves 20 formed in the lower surface. Bare fiber parts 3a of another optical fiber ribbon 3 are further placed in the positioning grooves 20 formed in the upper surface of the second alignment board 4, and another second alignment board 4 is superposed. In this way, it is possible to manufacture the optical connector ferrule 1 having optical fiber ribbons stacked in multiple layers.

Besides, plural positioning grooves 10 are formed in the lower surface of the first alignment board 12 like in the upper surface. Accordingly, after the bare fiber parts 3a are fixed to the positioning grooves 10 in the upper surface by the adhesive agent, the housing part 2 is reversed and thereby, the optical fiber ribbons 3 can be placed in the holding grooves 10 in the lower surface via the lower open part 19 through the same steps as described above.

Thus, as the four optical fiber ribbons are totally stacked at the upper and lower sides, the optical connector ferrule 1 is formed with four optical fiber ribbons stacked as shown in FIG. 1B. Here, stacking may be performed alternately on the upper and lower surfaces, for example, by immediately after stacking the optical fiber ribbon 3 on the upper surface of the first alignment board 12, reversing the housing part, stacking the optical fiber ribbon 3 on the first alignment board 12, reversing the housing part again and stacking the optical fiber ribbon 3 on the other surface. Besides, a jig for arranging the bare fiber parts 3a in the holding grooves 10 and positioning grooves 20 may be used in stacking.

According to this embodiment, the second alignment board 4 is self-aligned only by placing and fitting the positioning grooves 20 of the second alignment board 4 on the bare fiber parts 3a which are positioned and arranged in the plural holding grooves 10 of the first alignment board 12 as described above. In other words, it is possible to properly position the bare fiber parts 3a of the second alignment board 4 on the bare fiber parts 3a of the first alignment board 12 only by placing the second alignment board 4 on the bare fiber parts 3a of the first alignment board 12. With this structure, it is possible to manufacture the optical connector ferrule 1 with plural optical fiber ribbons 3 stacked by a simple work and without the conventional work of inserting the bare fiber parts 3a into insertion holes. That is, as the housing part containing the first alignment board 12 and the second alignment board are manufactured with the same accuracy and with the same shapes, the obtained optical connector ferrule is capable of proper positioning by self-aligning.

Accordingly, in manufacturing of the optical connector ferrule 1 according to this embodiment, there is no need to use a narrow long pin as a mold die. Therefore, the manufacturing of the die is simplified, and the manufacturing work of the ferrule is also simplified. Therefore, it is possible to reduce the manufacturing cost of the optical connector ferrule 1.

### Second Embodiment

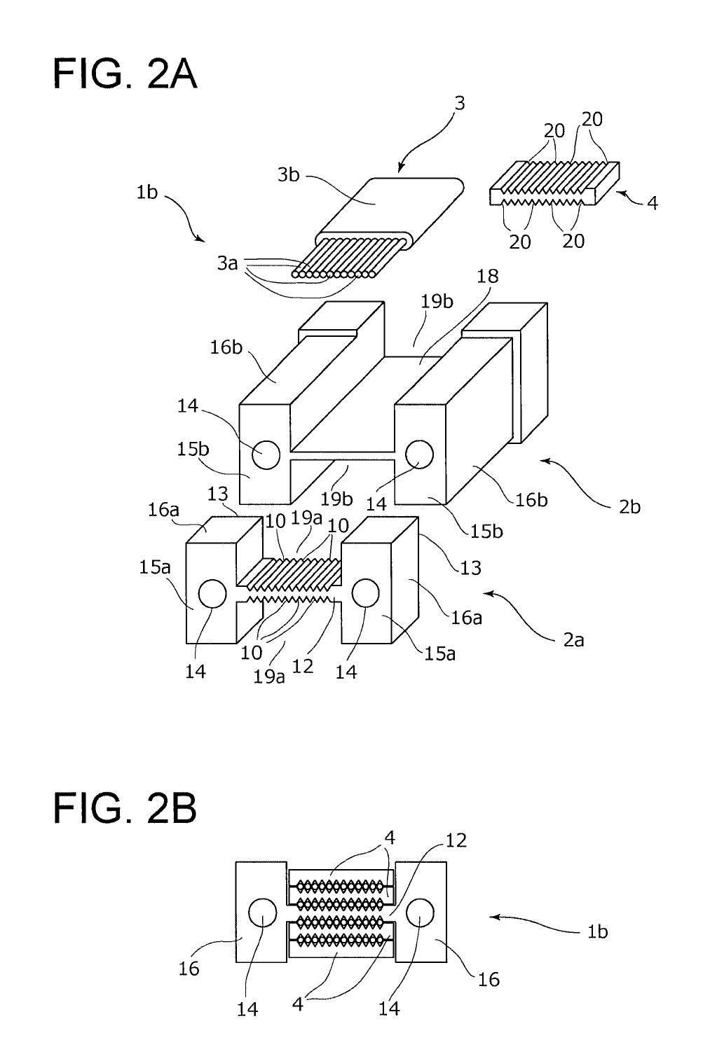

Next description is made, with reference to FIGS. 2A and 2B, about an optical connector ferrule 1 according to the second embodiment of the present invention. In the following description, like elements as those in the first embodiment are denoted by like reference numerals and its explanation is omitted here. FIG. 2A is an exploded perspective view illustrating the assembly process of an optical connector ferrule 1b according to the second embodiment of the present invention and FIG. 2B is a front view illustrating the optical connector ferrule 1b shown in FIG. 2A with four optical fiber ribbons 3 stacked.

The second embodiment shown in FIG. 2A is different from the first embodiment shown in FIG. 1A in that the housing part 2 is integrally formed in the first embodiment while the housing part 2 is formed of two separate parts, that is, a front housing part 2a and a back housing part 2b. The front housing part 2a has the first alignment board 12 and the back housing part 2b has the fiber support part 18.

That is, the optical connector ferrule 1b shown in FIG. 2A has a front housing part 2a, a back housing part 2b and the second alignment board 4.

The front housing part 2a has the first alignment board 12, paired side support parts 16a and an open part 19a. The first alignment board 12 and the paired side support parts 16a are formed into one piece. Besides, the back housing part 2b has the fiber support part 18, paired side support parts 16b and an open part 19b. The fiber support part 18 and the paired side support parts 16b are formed into one piece.

In this embodiment shown in FIG. 2A, first, a back part 13 of the front housing part 2a and a front part 15b of the back housing part 2b are connected to be the housing part 2 having the same shape as the housing part 2 of the first embodiment. Then, the completed housing part is used to perform the same assembly work as that in the first embodiment, thereby obtaining the optical connector ferrule 1b with four optical fiber ribbons 3 stacked as illustrated in FIG. 2B.

According to the present embodiment, the housing part 2 is formed of two separate parts, that is, the front housing part 2a and the back housing part 2b. With this structure, mold dies can be manufactured easily even when the housing part 2 is difficult to fabricate by integral molding, for example, when optical fiber ribbons used have more fibers, when the bare fiber parts 3a are long and/or when it is difficult to make the holding grooves 10 due to a complicated shape.

Besides, the same structure as that of the first embodiment may be obtained only by bonding the front housing part 2a to the back housing part 2b. Therefore, it is possible to obtain highly accurate assembly with a simple work and reduce the manufacturing cost like in the first embodiment.

### Third Embodiment

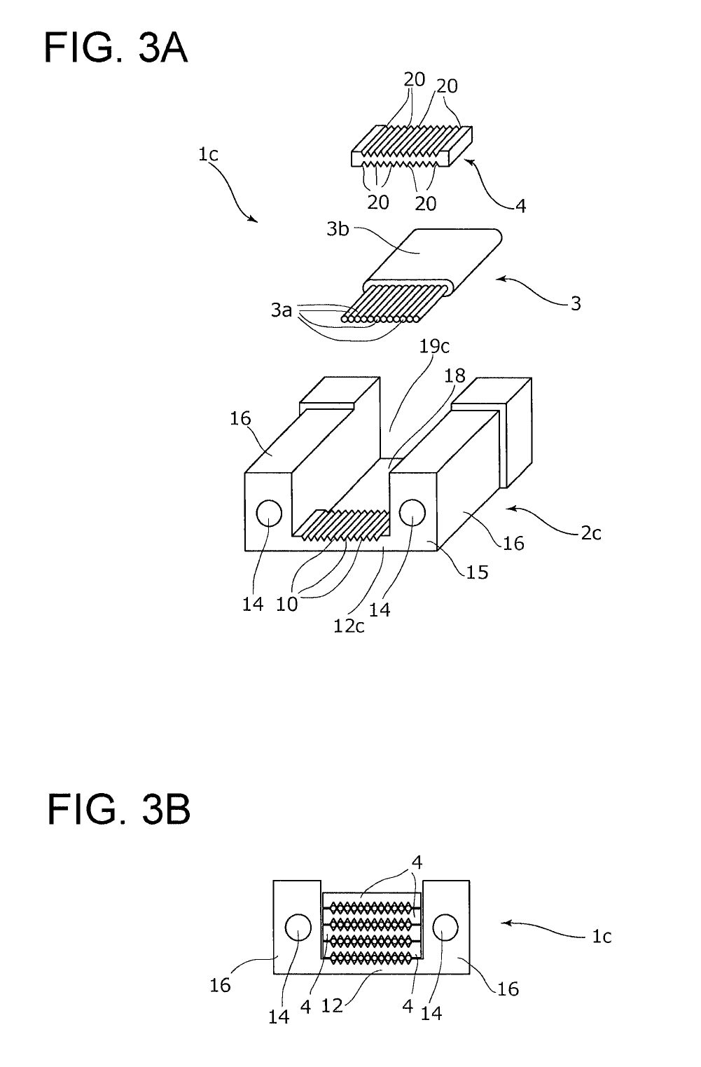

Next description is made, with reference to FIGS. 3A and 3B, about an optical connector ferrule according to the third embodiment of the present invention. FIG. 3A is an exploded perspective view illustrating the assembly process of the optical connector ferrule 1c according to the third embodiment of the present invention, and FIG. 3B is a front view of the optical connector ferrule 1c of FIG. 3A in which four optical fiber ribbons 3 are stacked.

The third embodiment of FIG. 3A is different from the first embodiment of FIG. 1A in that the first alignment board 12 is positioned at a lower part between the paired side support parts

The optical connector ferrule 1c illustrated in FIG. 3A has a housing part 2c and the second alignment board 4.

The housing part 2c has a first alignment board 12c with a plurality of holding grooves 10, the paired side support parts 16, the fiber support part 18 and an open part 19c.

As illustrated in FIG. 3A, the first alignment board 12c and the fiber support part 18 are arranged at the lower part of the paired side support parts 16 and their lower surfaces are flush with the lower surfaces of the paired side support parts 16. That is, the holding grooves 10 are formed only in the upper surface of the first alignment board 12c and the open part 19c is formed only above the holding grooves 10.

The optical connector ferrule 1c according to this embodiment is assembled in the same manner as the first embodiment. That is, the optical fiber ribbon 3 is placed on the first alignment board 12c via the open part 19c and bare fiber parts 3a are arranged into the holding grooves 10, respectively. The second alignment board 4 and an optical fiber ribbon 3 are superposed sequentially via the open part 19c and the holding grooves 10 and the positioning grooves 20 are fixed with use of an adhesive agent thereby assembling the optical connector ferrule 1c with four optical fiber ribbons 3 stacked as shown in FIG. 3B. In this embodiment, the open part 19c is formed above only one surface, there is no need to reverse the housing part 2c in the assembly work. With only a simple assembly process of superposing the parts sequentially and bonding them to each other, it is possible to manufacture the optical connector ferrule 1c with optical fiber ribbons 3 arranged properly and stacked with high accuracy. Therefore, the assembly work can be simplified and the manufacturing cost can be reduced.

### Fourth Embodiment

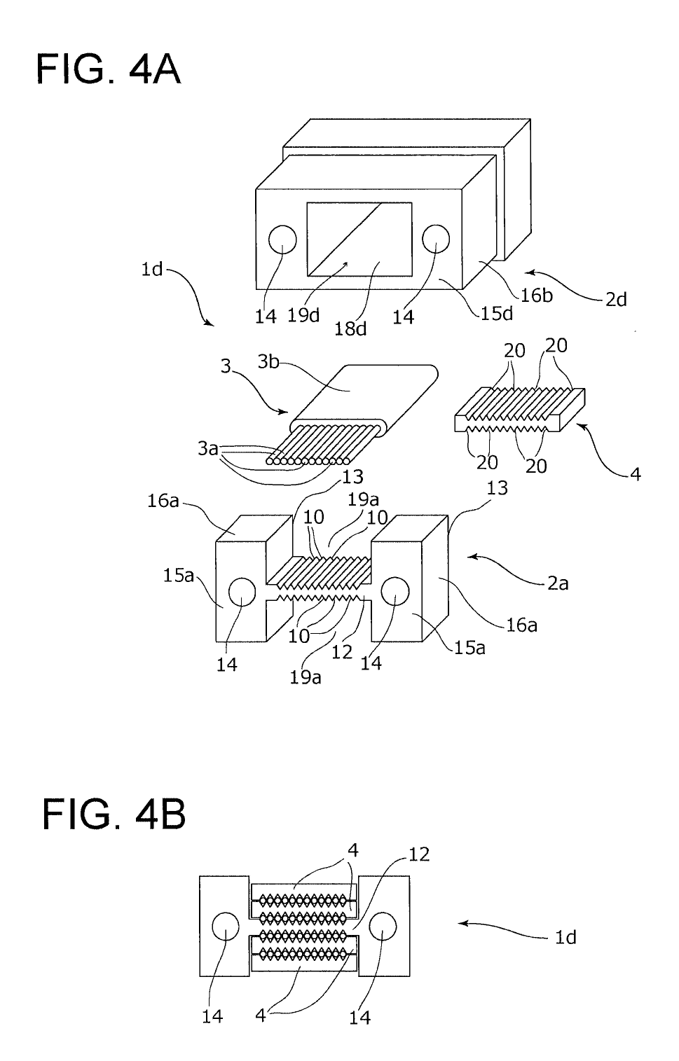

Next description is made, with reference to FIGS. 4A and 4B, about an optical connector ferrule according to the fourth embodiment of the present invention. FIG. 4A is an exploded perspective view of the assembly process of the optical connector ferrule 1d according to the fourth embodiment of the present invention and FIG. 4B is a front view of the optical connector ferrule shown in FIG. 4A in which four optical fiber ribbons 3 are stacked.

The fourth embodiment of FIG. 4A is different from the first embodiment of FIG. 1A in that a back housing part 2d is an approximately rectangular solid.

The optical connector ferrule 1d shown in FIG. 4A has a front housing part 2a, the back housing part 2d and the second alignment board 4.

The front housing part 2a is the same as that in the second embodiment and has the first alignment board 12, the paired side support parts 16a and the open part 19a. The back housing part 2d is an approximately rectangular solid as shown in FIG. 4A and has the fiber support part 18. Here, the back housing part 2d has a positioning guide hole 14 formed in the front part 15d at the same position as the front housing part 2a and a release hole 19d formed at the center.

The assembly process of the optical connector ferrule 1d of this embodiment is described.

In the optical connector ferrule 1d according to this embodiment, an optical fiber ribbon 3 is placed on the first alignment board 12 via the open part 19a and bare fiber part 3a are fit in the holding grooves 10, respectively. Then, the second alignment board 4 and an optical fiber ribbon 3 are superposed via the open part 19a sequentially and the holding grooves 10, the positioning grooves 20 are fixed by using an adhesive agent. Besides, the front housing part 2a and the back housing part 2d are bonded to each other by adjusting the positions of the positioning guide holes 14. Through this process, it is possible to manufacture the optical connector ferrule 1d with four optical fiber ribbons 3 stacked as shown in FIG. 4B.

Also in this embodiment, like in the second embodiment, the housing part 2 is formed of separate front housing part 2a and back housing part 2d. Since a die can be divided into two or more, the die for manufacturing can be manufactured easily even when the die is difficult to fabricate integrally due to difficult molding of holding grooves 10, long bare fiber parts 3a and using an optical fiber ribbon 3 having more fibers. Further, as the optical connector ferrule 1d can be fabricated only by superposing the optical fiber ribbon 3 and the second alignment board 4 via the open part 19a, the assembly becomes highly accurate only with a simple work and the manufacturing cost can be reduced.

### Fifth Embodiment

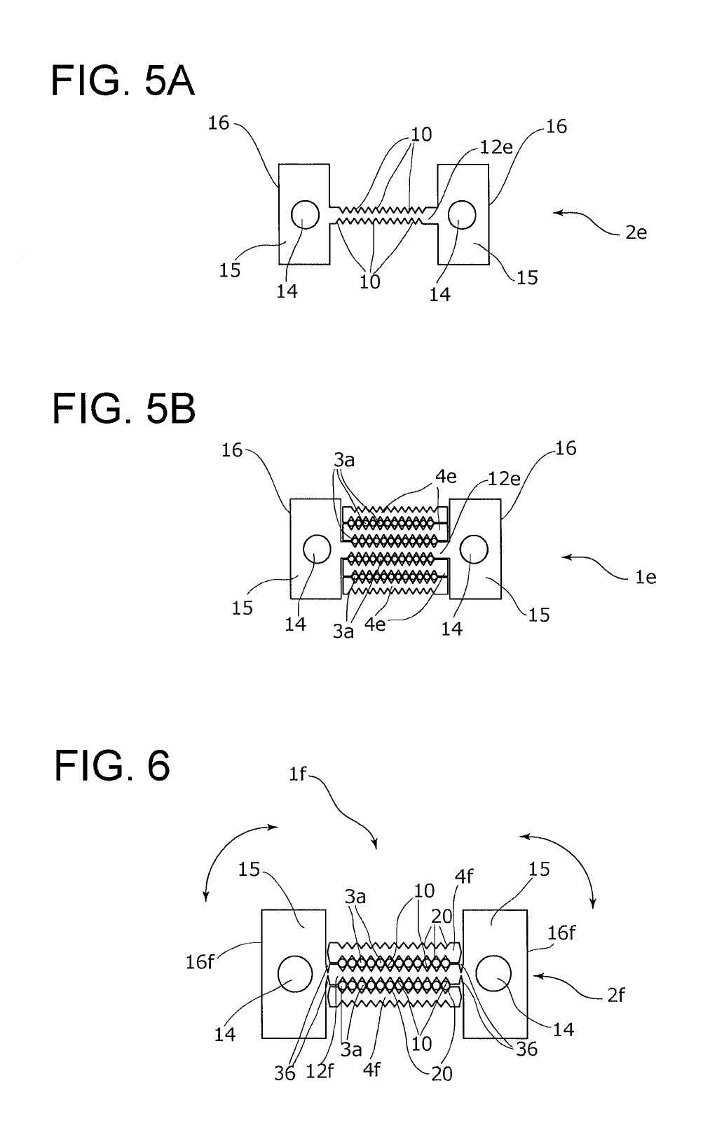

Next description is made, with reference to FIGS. 5A and 5B, about an optical connector ferrule according to fifth embodiment of the present invention. FIG. 5A is a front view illustrating a housing part 2e of the optical connector ferrule 1e according to the fifth embodiment of the present invention, and FIG. 5B is a front view of the housing part 2e shown in FIG. 5A with four optical fiber ribbons 3 stacked and fixed.

The fifth embodiment shown in FIG. 5A is different from the first embodiment shown in FIG. 1A in that the holding grooves 10 formed in the upper surface of the first alignment board 12e are formed a half pitch shifted from the holding grooves 10 in the lower surface thereof. Here, as illustrated in FIG. 5B, the positioning grooves 20 in the upper surface of the second alignment board 4e are also formed a half pitch shifted from those in the lower surface thereof.

Like in the first embodiment, the optical connector ferrule le according to the present embodiment shown in FIG. 5B is assembled by superposing the optical fiber ribbon 3 and the second alignment board 4e on the first alignment board 12e sequentially.

In this embodiment, as illustrated in FIGS. 5A and 5B, the holding grooves 10 in the upper surface of the first alignment board 12e and the positioning grooves 2 in the upper surface of the second alignment board 4e are formed a half pitch shifted from those formed in the lower surfaces of the first alignment board 12e and the second alignment board 4e. As the bottoms of the holding grooves 10 and the positioning grooves 20 are shifted by a half pitch, there is no excessively thin part formed in the first alignment board 12e and the second alignment board 4e. With this feature, it is possible to prevent damage in molding and assembling due to a crack at a thin part. Therefore, it is possible to reduce the thickness of the first alignment board 12e and the second alignment board 4e, thereby providing a more miniaturized optical connector ferrule.

### Sixth Embodiment

Next description is made, with reference to FIG. 6, about an optical connector ferrule according to the sixth embodiment of the present invention. FIG. 6 is a front view of the optical connector ferrule 1f according to the sixth embodiment of the present invention.

The optical connector ferrule 1f according to the sixth embodiment of the present invention shown in FIG. 6 is different from those in the first and second embodiments in that a pair of upper and lower notch parts 36 is provided between the first alignment board 12f and a pair of side support parts 16f.

In this way, as the pair of notch parts 36 is provided, when the paired side support parts 16f are turned in the direction of the arrow shown in FIG. 6, the first alignment board 12f and the paired side support parts 16f are broken and separated from each other. This separated first alignment board 12f can be used as the second alignment board 4f. Therefore, the second alignment board 4 can be manufactured only with use of the mold die of the housing part 2f and no specific mold die is required for the second alignment board 4f. Here, in this embodiment, the V-groove type notch parts 36 are provided, however, this shape is not intended for limiting the invention and any other shape may be adopted as far as the first alignment board 12f and the paired side support parts 16 are separable.

### Seventh Embodiment

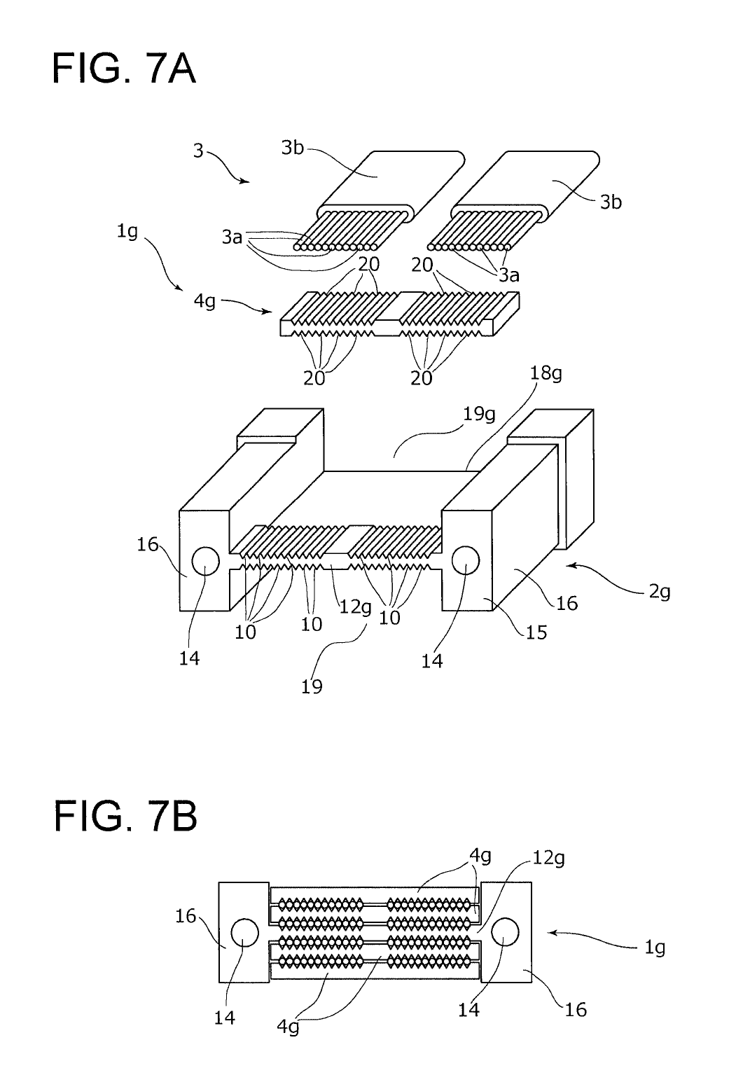

Next description is made, with reference to FIGS. 7A and 7B, about an optical connector ferrule according to the seventh embodiment of the present invention. FIG. 7A is an exploded perspective view of the assembly process of the optical connector ferrule 1g according to the seventh embodiment of the present invention and FIG. 7B is a front view of the optical connector ferrule 1g shown in FIG. 7A in which four optical fiber ribbons 3 are stacked.

The seventh embodiment shown in FIG. 7A is different from the first embodiment shown in FIG. 1A in that a first alignment board 12g as shown in FIG. 1A is formed of two alignment boards 12 arranged in the width direction and formed into one piece. Besides, the second alignment board 4g has a shape corresponding to the first alignment board. In this embodiment, the alignment boards 12g, 4g are formed of two and formed into one piece, however the length of each of the alignment boards 12g, 4g may be changed according to need.

According to the present embodiment, as illustrated in FIG. 7A, two optical fiber ribbons 3 are placed on the first alignment board 12g from the open part 19g, the bare fiber parts 3a are arranged in the holding grooves 10, respectively and the covered part 3b is placed on the fiber support part 18. Then, the same steps as those in the first embodiment are repeated. In this way, it is possible to manufacture the optical connector ferrule 1g as shown in FIG. 7A such that plural optical fiber ribbons 3 are arranged in the width direction and also stacked in the height direction.

According to this embodiment, if the space in the height direction is limited, the plural first alignment boards 12 are formed into one piece in the width direction, thereby enabling to provide the optical connector ferrule such that plural optical fiber ribbons can be placed thereon.

### Other Embodiments

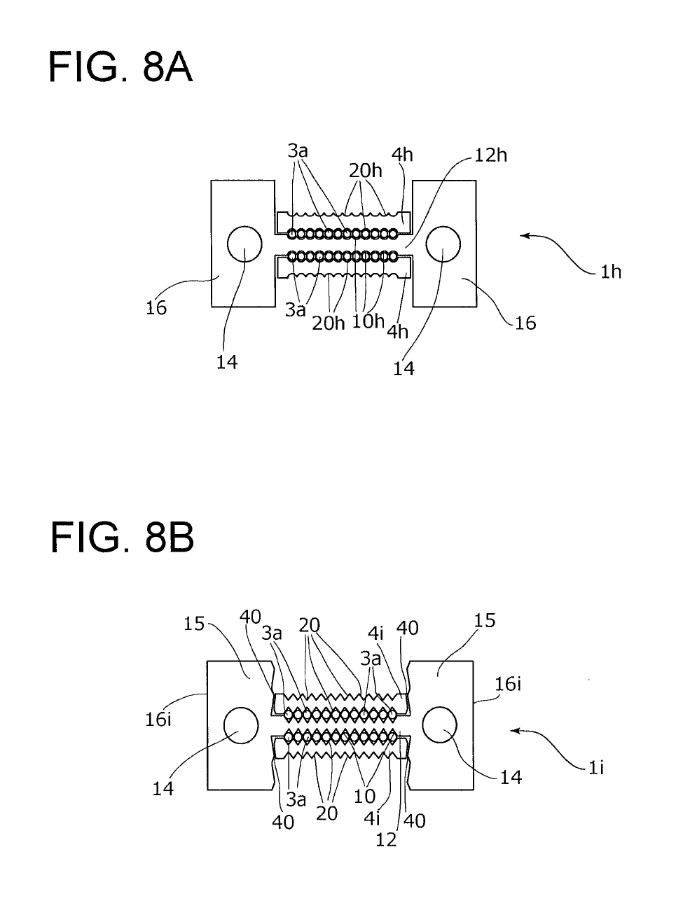

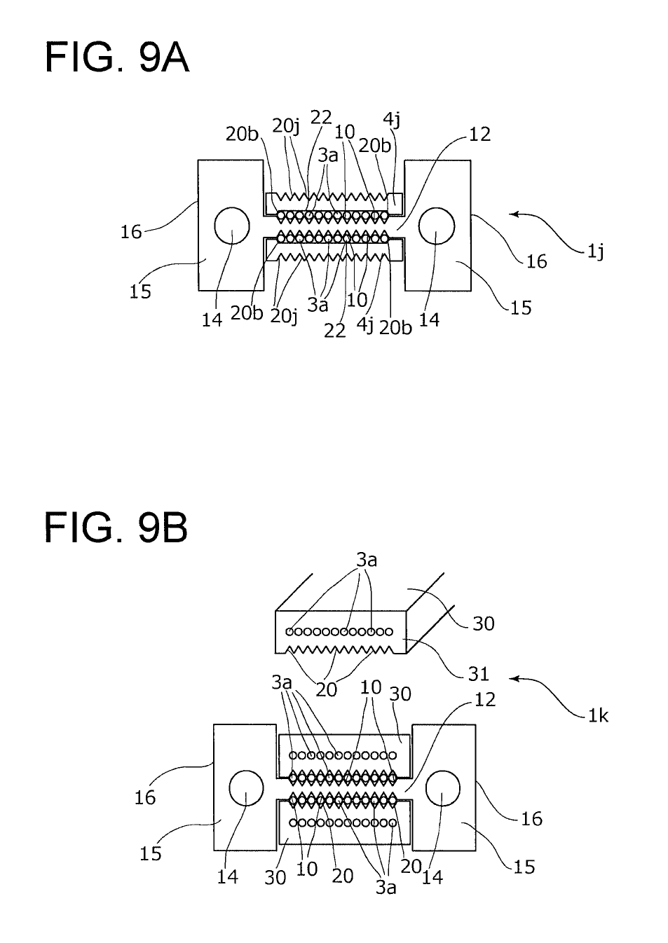

Next description is made, with reference to FIGS. 8A, 8B, 9A and 9B, about optical connector ferrules according to other embodiments of the present invention.

In the above-described embodiment, all of the holding grooves have V-shaped cross sections, however, this is not intended for limiting the present invention. For example, as illustrated in FIG. 8A, U-shaped grooves 10h may be formed as holding grooves. In the embodiment illustrated in FIG. 8A, the holding grooves 10h of the first alignment board 12h and the positioning grooves 20h of the second alignment board 4h are formed at a predetermined pitch in such a manner as to be symmetrical in upper and lower surfaces. These grooves have U-shaped cross sections. As U-shaped grooves are shallow, it is possible to reduce a thin part as compared with the case of V-shaped grooves. Accordingly, it is possible to prevent any damage due to a crack at a thin part in molding or assembling. That is, the optical connector ferrule 1h with optical fiber ribbons 3 can be manufactured with a simpler assembly work.

In the embodiment shown in FIG. 8B, a holding part 40 is formed in each side surface of each of paired side support parts 16i that is in contact with the second alignment board 4i. When the second alignment board 4i is inserted onto the bare fiber parts 3a, the paired side support parts 16i are bent to the side opposite to the second alignment board 4i insertion side, thereby enabling the second alignment board 4i toward the first alignment board 12.

When the second alignment board 4i is inserted at a predetermined position, the paired side support parts 16i return to their original positions by an elastic force of the material. Therefore, the second alignment board 4i becomes held by the holding parts 40. In other words, as the second alignment board 4i is held by the paired side support parts 16i, the optical connector ferrule 1i can be obtained which optical fiber ribbons are held by the second alignment board 4i in a simple manner without application of any adhesive agent.

In the embodiment illustrated in FIG. 9A, in the lower surface of the second alignment board 4j, there are formed positioning grooves 20b for fitting the bare fiber parts 3a arranged in the first alignment board 12 and a fixing part 22 for pressing down and fixing the bare fiber parts 3a. Besides, in the upper surface of the second alignment board 4j, V-shaped positioning grooves 20j are formed at the same positions in the width direction at the same pitch as the holding grooves 10 of the first alignment board 12. Accordingly, the bare fiber parts 3a arranged in the holding grooves 10 are defined in the width direction by the positioning grooves 20b provided at both ends of the second alignment board 4j and pressed in the height direction by the fixing part 22. Besides, the positioning grooves 20j provided in the upper surface of the second alignment board 4j are used to be able to align the bare fiber parts 3a like in the first embodiment. With this structure, it is possible to create the highly accurate optical connector ferrule 1j by a simple assembly work. Here, in this embodiment, the positioning grooves 20b are formed at both ends, however, they may be formed at any other positions as far as alignment in the width direction cab be made.

Here, as to the positioning grooves 20 of the second alignment board in every embodiment including the above-described first embodiment, their positions in the width direction are determined by the bare fiber parts 3a arranged in the first alignment board 12. In the embodiment of FIG. 9, a pair of positioning grooves 20b provided at left and right ends is used to position the second alignment board 4j in such a manner as to match the bare fiber parts.

In the embodiment shown in FIG. 9B, a ferrule 30 with optical fibers inserted is used as the second alignment board 4. Ina front part 31 of the ferrule 30, insertion holes are formed and bare fiber parts 3a are inserted into those holes. Besides, in order to serve as the second alignment board 4, in the lower surface of the ferrule 30, V-shaped positioning grooves 20 are formed at the same pitch as the first alignment board 12. Accordingly, the ferrule 30 is placed on the first alignment board 12 with the bare fiber parts 31 arranged on and is superposed thereon in such a manner that the bare fiber parts 3a are fit in the positioning grooves 20, respectively, thereby positioning the bare fiber parts 3a and the ferrule 30. That is, the highly accurate optical connector ferrule 1k can be manufactured only by a simple assembly work. Here, the one-row ferrule 30 is adopted in this embodiment, however, two rows or more of ferrules may be adopted according to need.

Here, the characteristic structures of the above-described embodiments are not intended for limiting the present invention, and may be adopted in combination appropriately. Besides, any modifications may be added to the embodiments described above.

For example, in the above-described embodiments, the holding grooves have V or U shaped cross sections. However, they may be trapezoidal, semicircular, rectangular or the like. In addition, the groove may have V-shaped upper surfaces and a U shaped bottom surface, and any shapes may be adopted in combination when necessary. Further, the numbers of bare fiber parts and holding grooves are not limited to twelve and may be any number more than one. However, peculiar effects of the present invention appear when there are a large number of optical fibers connected. Further, the positioning grooves provided in the upper surface of the second alignment board are equal in number to those provided in the lower surface thereof. However, they may be changed appropriately in accordance with the number of the core fibers of the optical fiber ribbon. Here, the positioning guide holes for fitting to another ferrule may have any shape as far as the ferrules can be positioned properly, and not limited to pins and guide holes. They may be combination of projections and recesses or grooves with which positioning is made by assembling ferrules. Further, the fiber support part may be provided in the second alignment board to support the covered part of the optical fiber ribbon.

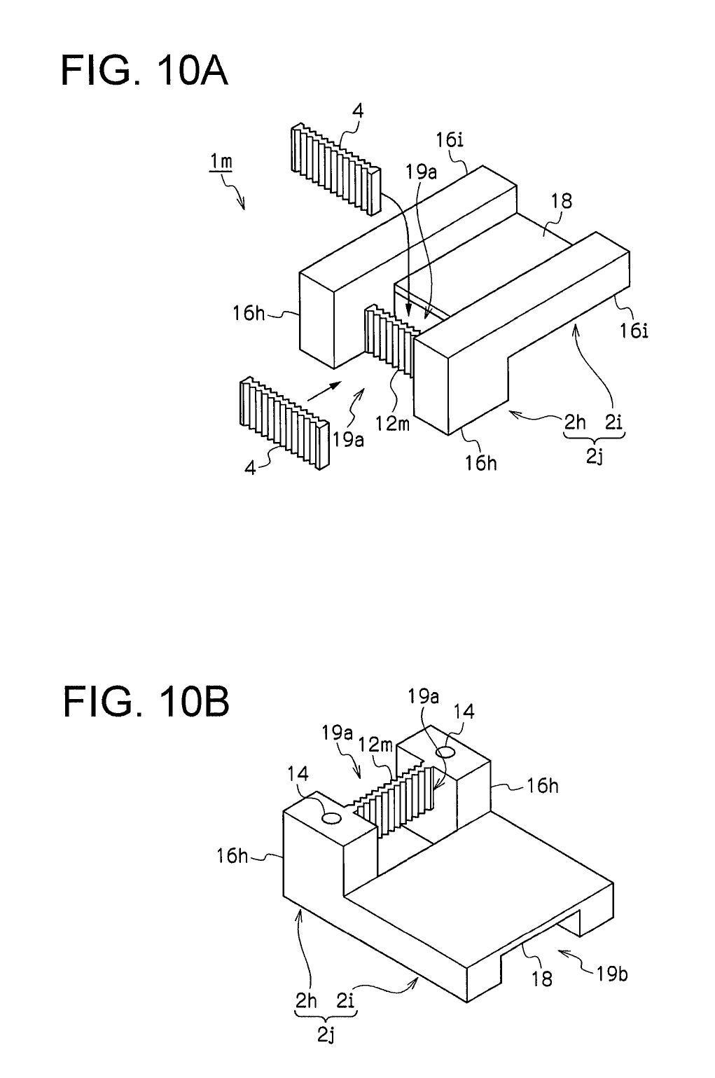

FIGS. 10A and 10B illustrate yet another embodiment. In this embodiment, an optical connector ferrule lm is used for connecting optical fiber ribbons bent at 90 degrees.

In a recent trend, attention is focused on the technique of changing the light path by bending an optical fiber ribbon at 90 degrees. Further, recently, there is a demand for stacking such optical fiber ribbons in plural stages thereby to enhance the packaging density of the optical fibers. The optical connector ferrule according to the embodiment shown in FIGS. 10A and 10B responds to these demands.

FIG. 10A is a perspective view illustrating an example of this embodiment and FIG. 10B is a perspective view illustrating the back side. The optical connector ferrule according to this embodiment has a front housing part 2h and a back housing part 2i with a fiber support part, which are bent at approximately 90 degrees into L shape. They are both formed integrally. The front housing part 2h has the first alignment board 12m between the left and right side support parts 16. The back housing part 2i is provided with a recess-shaped support part 18 for supporting optical fiber ribbons.

The first alignment board 12m has a plurality of holding grooves 10 formed in the front and back surfaces, like in other embodiments. The first alignment board 12m is positioned at the center of the paired side support parts 16h, bare fiber parts 3a of the optical fiber ribbons 3 are arranged in the holding grooves 10 in the both surfaces of the first alignment board 12m and pressed by the second alignment boards 4. In FIGS. 10A and 10B, the first alignment board 12m is configured to be provided at the center of the paired side support parts 16h, however, it may be placed nearer either side of the side support parts 16h like in the above described embodiment.

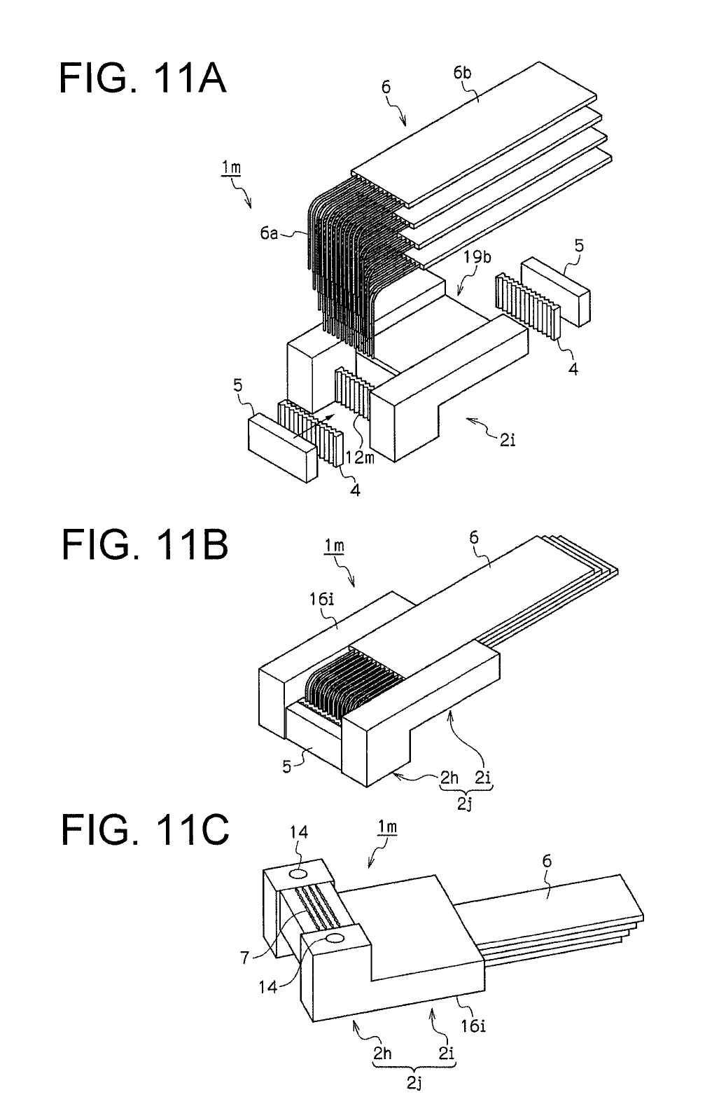

The assembly process of connecting optical fibers to the optical connector ferrule lm according to the embodiment shown in FIGS. 10A and 10B is described with reference to FIGS. 11A to 11C. As described above, in this embodiment, connected optical fiber ribbons 6 have bare fiber parts 6a bent about 90 degrees.

First, as illustrated in the perspective view of FIG. 11A, an optical fiber ribbon with the bare fiber parts 6a approximately 90-degree bent at the end is prepared and the bare fiber parts 6a are arranged in the holding grooves 10 of the first alignment board 12m. The covered part 6b of the optical fiber ribbon 6 is placed on the fiber support part 18.

The bare fiber parts 6a of the plural optical fiber ribbons 6 are layered sequentially via the second alignment boards 4 and its outer parts are covered with cover members 5 and adhesive-cured into the state shown in FIG. 11B. Then, the connection end surface 7 of the optical fiber connector is polished. With these steps, the optical connector ferrule with optical fibers connected (optical connector) is completed as illustrated in FIG. 11C. FIG. 11C is a perspective view of the optical connector of FIG. 11B seen from the opposite side (bottom side).

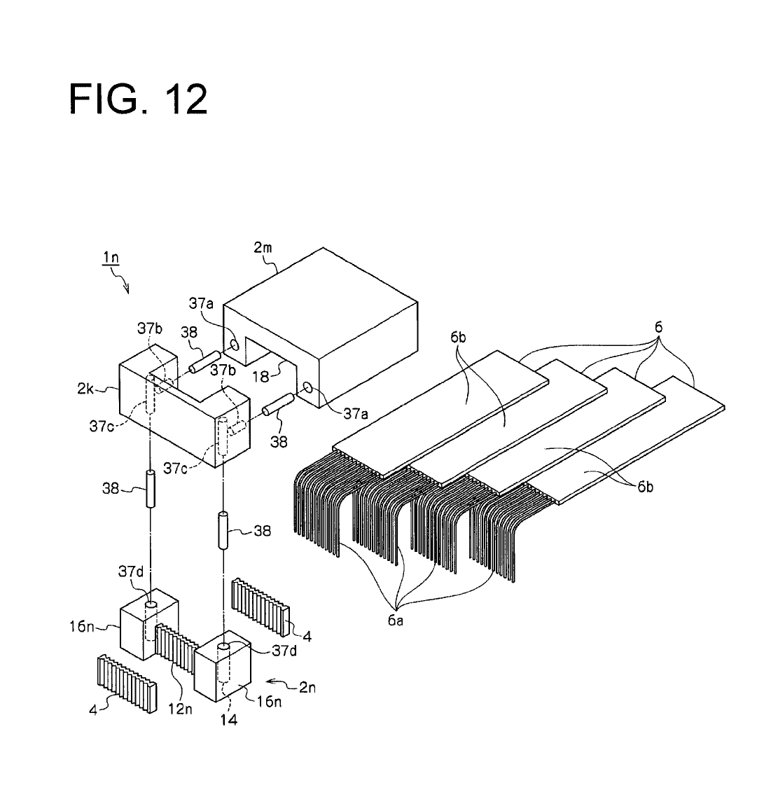

With reference to FIG. 12, description is made about another embodiment of the preset embodiment. Also in the embodiment shown in FIG. 12, 90-degree bent optical fiber ribbons 6 are stacked. In the embodiment shown in FIG. 12, the optical connector ferrule In has three housing parts, that is, a front protective housing part 2k, a back protective housing part 2m and a positioning housing part 2n. The front protective housing part 2k and the back protective housing part 2m may be formed integral with each other. As the housing is thus structured of separated parts, the assembly work of placing optical fiber ribbons on is facilitated. Besides, the mold die is also easy to manufacture. These three housing parts 2k, 2m and 2n may be connected with connecting pins 38. The connecting pins 38 are fit in respective fitting holes 37a to 37d and fixed with an adhesive agent, if necessary.

As to the assembly process, for example, first the front protective housing part 2k and the back protective housing part 2m are connected to each other. Then, the bare fiber parts 6a of the optical fiber ribbon 6 are arranged in the holding grooves 10 of the first alignment board 12n of the positioning housing part 2n. After that, the connecting pins 38 are used to fix the front housing part 2k to the positioning housing part 2n, thereby completing assembly of the optical connector ferrule and optical fiber ribbons.

### REFERENCE NUMERALS

1, 1b to 1k optical connector ferrule

2,2a to 2n housing part

3,6 optical fiber ribbon (multi-fiber ribbon)

4, 4a, 4g, 4h, 4i, 4j second alignment board

10 holding groove

12, 12c, 12f, 12g, 12h, 12m, 12n first alignment board

13 back part

14 positioning guide hole

15, 15a, 15b, 15d front part

16, 16a, 16b, 116h, 16i, 16n side support part

18 fiber support part

19, 19a, 19b open part

19d release hole

20, 20b, 20i, 20h, 20j positioning groove

22 fixing part

30 ferrule

31 ferrule front part

36 notch part

37a to 37d fitting hole

38 connecting pin

1. An optical connector ferrule comprising:
a housing part having a first alignment board and a pair of side support parts, the first alignment board having at least one surface in which a plurality of bare fiber parts of an optical fiber ribbon are positioned in a width direction at a predetermined pitch and having a plurality of holding grooves for arranging the bare fiber parts in alignment, the side support parts being formed integral with the first alignment board, supporting both ends of the first alignment board and having an open part in at least one of a upper surface side and a lower surface side of the first alignment board, the open part being larger than a width of the optical fiber ribbon; and
a second alignment board having a positioning part for positioning in the width direction and in engagement at least a part of the bare fiber parts placed on the holding grooves of the first alignment board and a fixing part for pressing and fixing the bare fiber parts, the second alignment board being arranged and adhesive-fixed so as to face the first alignment board of the housing part and to sandwich the bare fiber parts.

2. The optical connector ferrule of claim 1, wherein the second alignment board has one surface in which positioning grooves for fitting the bare fiber parts are provided, has an opposite surface in which another positioning grooves for placing another optical fiber ribbon having a plurality of bare fiber parts and is inserted into the open part in an up and down direction.

3. The optical connector ferrule of claim 2, wherein a plurality of the second alignment boards are stacked.

4. The optical connector ferrule of claim 2, wherein a height of the second alignment board is lower than heights of the side support parts.

5. The optical connector ferrule of claim 3, wherein all of the second alignment boards have widths narrower than a width of the open part.

6. The optical connector ferrule of claim 1, wherein the each side support part has a front part in which a guide hole for positioning is provided.

7. The optical connector ferrule of claim 2, wherein the holding grooves are formed in both surfaces of the first alignment board.

8. The optical connector ferrule of claim 7, wherein the first alignment board is formed at a center between the side support parts.

9. The optical connector ferrule of claim 2, wherein the first alignment board has a fiber support part for supporting a covered part of the optical fiber ribbon in which optical fibers are covered.

10. The optical connector ferrule of claim 9, wherein the housing part has a front housing part having the first alignment board and a back housing part having the fiber support part.

11. The optical connector ferrule of claim 8, wherein the holding grooves formed are provided symmetrical between one surface of the first alignment board and an opposite surface thereof.

12. The optical connector ferrule of claim 2, wherein the holding grooves of the first alignment board and the positioning grooves of the second alignment board are V shaped grooves having V shaped cross sections.

13. The optical connector ferrule of claim 2, wherein the holding grooves of the first alignment board and the positioning grooves of the second alignment board are U shaped grooves having U shaped cross sections.

14. The optical connector ferrule of claim 12, wherein the holding grooves of the first alignment board and the positioning grooves of the second alignment board are shifted horizontally from each other by a half pitch.

15. The optical connector ferrule of claim 13, wherein the holding grooves of the first alignment board and the positioning grooves of the second alignment board are shifted horizontally from each other by a half pitch.

16. The optical connector ferrule of claim 1, wherein the first alignment board has a plurality of notch parts for separating from the side support parts.

17. The optical connector ferrule of claim 9, wherein the housing part has a front housing part having the first alignment board and a back housing part having the fiber support part,
the back housing part is formed integrally with the front housing part so as to form a L shape while the optical fiber ribbon having an end part in which the bare fiber parts are bent about 90 degrees is provided on the first alignment board, the covered part is provided on the fiber support part, the second alignment board is stocked on the first alignment board and
the bare fiber parts bent about 90 degrees in an end part of another optical fiber ribbon are placed on the second alignment board.

18. The optical connector ferrule of claim 17, wherein the fiber support part is spaced from the first alignment board.
